(19) United States
(12) Patent Application Publication
(10) Pub. No.: US 2026/0245170 A1
(43) Pub. Date: Aug. 20, 2026

(54) IMAGE PROCESSING METHOD, WEARABLE DEVICE, AND WEARABLE SYSTEM

(71) Applicant: Beijing Zitiao Network Technology Co., Ltd., Beijing (CN)

(72) Inventors: Xiaobin LI, Beijing (CN); Jinbo XUE, Beijing (CN)

(21) Appl. No.: 19/381,777

(22) Filed: Nov. 6, 2025

(30) Foreign Application Priority Data
Feb. 17, 2025 (CN) 202510176722.0
May 26, 2025 (CN) 202510686801.6

(51) Int. Cl. G06T 1/60; G10L 15/22

(52) U.S. Cl. CPC G06T 1/60; G10L 15/22; G10L 2015/223

(57) ABSTRACT

Embodiments of the present disclosure provide an image processing method, a wearable device, and a wearable system, which relate to the field of computer technologies. The method includes: when a user wears the wearable device, controlling a camera to shoot a current environment to obtain a first original image file in response to a shooting instruction; and after the wearable device is placed in the storage apparatus, sending the first original image file to the storage apparatus, where the storage apparatus is configured to store the wearable device when the wearable device is not worn, and the storage apparatus is capable of processing the first original image file.

### CROSS-REFERENCE TO RELATED APPLICATIONS

This application claims the priority of Chinese Patent Application No. 202510176722.0 filed on February 17, 2025, and the priority of Chinese Patent Application No. 202510686801.6 filed on May 26, 2025, the disclosure of which is incorporated by reference herein in its entirety as part of the present application.

### TECHNICAL FIELD

Embodiments of the present disclosure relate to the field of computer technologies, and in particular, to an image processing method, a wearable device, a wearable system, a storage apparatus, an electronic device, and a medium.

### BACKGROUND

A wearable device is an electronic device worn on a user. The wearable device is generally configured to provide multiple functions such as audio and/or video.

At present, a shooting function is added to the wearable device. However, due to limited space of the wearable device, the wearable device cannot carry a large-sized ISP (Image Signal Processing) chip, which results in relatively low quality of images shot by the wearable device. In addition, the effect of processing image data by a small-sized ISP chip is poor, which in turn affects the photographing effect of the wearable device.

### SUMMARY

Embodiments of the present disclosure provide an image processing method, a wearable device, a storage apparatus, and an electronic device, which are used to solve the problem in the prior art that the quality of images shot by a wearable device is relatively low.

An embodiment of the present disclosure provides an image processing method, which is applied to a wearable device. The wearable device includes a camera, and the method includes: when a user wears the wearable device, controlling the camera to shoot a current environment to obtain an original image file in response to a shooting instruction; and after the wearable device is placed in a storage apparatus, sending the original image file to the storage apparatus, where the storage apparatus is configured to store the wearable device when the wearable device is not worn, and the storage apparatus is capable of processing the original image file.

An embodiment of the present disclosure provides an image processing method, which is applied to a storage apparatus. The storage apparatus is configured to store a wearable device when the wearable device is not worn, and the method includes: after the wearable device is placed in the storage apparatus, receiving an original image file sent by the wearable device; and processing the original image file.

An embodiment of the present disclosure provides an image processing method, which is applied to a wearable device. The wearable device includes a camera, and the method includes: when a user wears the wearable device, controlling the camera to shoot a current environment to obtain an original image file in response to a shooting instruction; and after the wearable device is placed in a storage apparatus, sending the original image file to the storage apparatus, where the storage apparatus is configured to store the wearable device when the wearable device is not worn, and the storage apparatus is capable of processing the original image file to obtain a first viewable image.

An embodiment of the present disclosure provides an image processing method, which is applied to a storage apparatus. The storage apparatus is configured to store a wearable device when the wearable device is not worn, and the method includes: after the wearable device is placed in the storage apparatus, receiving an original image file sent by the wearable device; and processing the original image file to obtain a first viewable image.

An embodiment of the present disclosure provides a wearable device. The wearable device includes a camera and the wearable device includes:

a control unit, configured to: when a user wears the wearable device, control the camera to shoot a current environment to obtain an original image file in response to a shooting instruction; and

a sending unit, configured to: after the wearable device is placed in a storage apparatus, send the original image file to the storage apparatus, where the storage apparatus is configured to store the wearable device when the wearable device is not worn, and the storage apparatus is capable of processing the original image file to obtain a first viewable image.

An embodiment of the present disclosure provides a storage apparatus, which is configured to store a wearable device when the wearable device is not worn. The storage apparatus includes:

a receiving unit, configured to: after the wearable device is placed in the storage apparatus, receive an original image file sent by the wearable device; and

a processing unit, configured to process the original image file to obtain a first viewable image.

An embodiment of the present disclosure provides a wearable system, which includes: a wearable device and a storage apparatus, where the storage apparatus is configured to store the wearable device when the wearable device is not worn;

the wearable device is configured to: when a user wears the wearable device, control a camera to shoot a current environment to obtain an original image file in response to a shooting instruction; and after the wearable device is placed in the storage apparatus, send the original image file to the storage apparatus; and

the storage apparatus is configured to process the original image file, for example, to obtain a first viewable image.

An embodiment of the present disclosure provides an image processing method, which is applied to a wearable device, where the wearable device includes a first image processing module and a camera, and the method includes:

when a user wears the wearable device, controlling the camera to shoot a current environment to obtain a first original image file in response to a shooting instruction;

after the wearable device is placed in a storage apparatus, sending the first original image file to the storage apparatus, so that the storage apparatus processes the first original image file to obtain a second original image file; where the storage apparatus is configured to store the wearable device when the wearable device is not worn; and

receiving the second original image file returned by the storage apparatus, and processing the second original image file by the first image processing module to obtain a first viewable image.

An embodiment of the present disclosure provides an image processing method, which is applied to a storage apparatus, where the storage apparatus is configured to store a wearable device when the wearable device is not worn, and the method includes:

after the wearable device is placed in the storage apparatus, receiving a first original image file sent by the wearable device; and

processing the first original image file by a second image processing module to obtain a second original image file.

An embodiment of the present disclosure provides a wearable device, where the wearable device includes a first image processing module and a camera, and the wearable device includes:

a controlling unit, configured to: when a user wears the wearable device, control the camera to shoot a current environment to obtain a first original image file in response to a shooting instruction;

a sending unit, configured to: after the wearable device is placed in a storage apparatus, send the first original image file to the storage apparatus, so that the storage apparatus processes the first original image file to obtain a second original image file; where the storage apparatus is configured to store the wearable device when the wearable device is not worn; and

a first processing unit, configured to receive the second original image file returned by the storage apparatus, and process the second original image file by the first image processing module to obtain a first viewable image.

An embodiment of the present disclosure provides a storage apparatus, where the storage apparatus is configured to store a wearable device when the wearable device is not worn, and the storage apparatus includes:

a receiving unit, configured to: after the wearable device is placed in the storage apparatus, receive a first original image file sent by the wearable device; and

a second processing unit, configured to process the first original image file by a second image processing module to obtain a second original image file.

An embodiment of the present disclosure provides a wearable system, including: a wearable device and a storage apparatus, where the storage apparatus is configured to store the wearable device when the wearable device is not worn;

the wearable device is configured to: when a user wears the wearable device, control a camera to shoot a current environment to obtain a first original image file in response to a shooting instruction; and after the wearable device is placed in the storage apparatus, send the first original image file to the storage apparatus;

the storage apparatus is configured to: after the wearable device is placed in the storage apparatus, receive the first original image file sent by the wearable device; and process the first original image file by a second image processing module to obtain a second original image file; and

the wearable device is further configured to receive the second original image file returned by the storage apparatus, and process the second original image file by a first image processing module to obtain a first viewable image.

An embodiment of the present disclosure provides an electronic device, which includes: a processor and a memory;

the memory stores a computer-executable instruction; and

the processor executes the computer-executable instruction stored in the memory to cause at least one processor to execute various possible image processing methods according to the above embodiments.

An embodiment of the present disclosure provides a computer-readable storage medium, where a computer-executable instruction is stored in the computer-readable storage medium. When the computer-executable instruction is executed by a processor, various possible image processing methods according to the above embodiments are implemented.

An embodiment of the present disclosure provides a computer program product, which includes a computer program. When the computer program is executed by a processor, various possible image processing methods according to the above embodiments are implemented.

### BRIEF DESCRIPTION OF DRAWINGS

In order to illustrate the technical solutions in the embodiments of the present disclosure or in the prior art more clearly, the drawings required in describing the embodiments or the prior art will be briefly introduced below. Apparently, the drawings in the following description are some embodiments of the present disclosure, and other drawings may also be obtained by a person of ordinary skill in the art according to these drawings without creative efforts.

FIG. 1 is an example diagram of an application scenario of an image processing method provided by an embodiment of the present disclosure;

FIG. 2 is a flowchart of an image processing method provided by an embodiment of the present disclosure;

FIG. 3 is a schematic structural diagram of a wearable device and a storage apparatus provided by an embodiment of the present disclosure;

FIG. 4 is a flowchart of another image processing method provided by an embodiment of the present disclosure;

FIG. 5 is a structural block diagram of a wearable device provided by an embodiment of the present disclosure;

FIG. 6 is a structural block diagram of a storage apparatus provided by an embodiment of the present disclosure;

FIG. 7 is a schematic structural diagram of an electronic device provided by an embodiment of the present disclosure

FIG. 8 is an example diagram of an application scenario of an image processing method provided by an embodiment of the present disclosure;

FIG. 9 is a flowchart of an image processing method provided by an embodiment of the present disclosure;

FIG. 10 is a schematic diagram of file transmission between a wearable device and a storage apparatus provided by an embodiment of the present disclosure;

FIG. 11 is a flowchart of another image processing method provided by an embodiment of the present disclosure;

FIG. 12 is a structural block diagram of a wearable device provided by an embodiment of the present disclosure; and

FIG. 13 is a structural block diagram of a storage apparatus provided by an embodiment of the present disclosure.

### DETAILED DESCRIPTION

In order to make objectives, technical solutions, and advantages of embodiments of the present disclosure clearer, the technical solutions in the embodiments of the present disclosure will be described clearly and comprehensively with reference to the drawings in the embodiments of the present disclosure. Apparently, the described embodiments are some embodiments of the present disclosure, rather than all the embodiments. All other embodiments obtained by a person of ordinary skill in the art based on the embodiments of the present disclosure without creative efforts shall fall within the protection scope of the present disclosure.

It may be understood that before the technical solutions disclosed in the embodiments of the present disclosure are used, a target user shall be informed of the type, range of use, use scenarios, etc., of personal information involved in the present disclosure in an appropriate manner and the authorization of the target user shall be obtained in accordance with relevant laws and regulations.

It may be understood that the above process of notifying and acquiring the authorization of the target user is only illustrative and does not constitute a limitation on the implementations of the present disclosure, and other manners that satisfy the relevant laws and regulations may also be applied to the implementations of the present disclosure.

In the related art, to add a shooting function to a wearable device, in addition to adding a shooting module, an ISP chip also needs to be added to process image data. The stronger the image processing capability of the ISP chip, the larger the package size of the ISP chip and the greater the power consumption. In the wearable device with limited space, only a small-sized, low-power ISP chip may be deployed, which results in relatively low quality of images shot by the wearable device.

To solve the technical problem, the present disclosure provides an image processing method. A camera configured in a wearable device is used to shoot an original image file, but a storage apparatus of the wearable device is used to process the original image file to obtain a first viewable image with high image quality later. In addition, it is also possible to process the original image file shot when a user wears the wearable device after the wearable device is stored.

According to the present disclosure, the storage apparatus may be used to process the original image file, so that the first viewable image can be obtained later according to the original image file acquired by the camera disposed on the wearable device, thereby improving the quality of the shot image.

The image processing method provided in the embodiments of the present disclosure will be described in detail below with reference to the drawings.

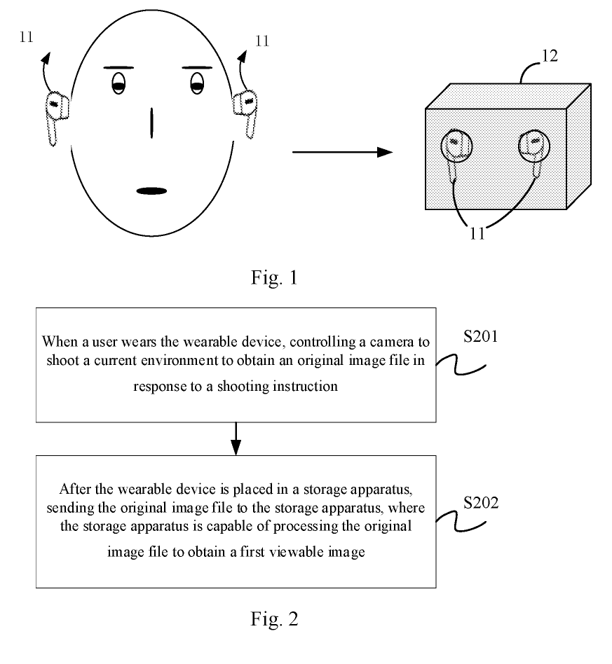

FIG. 1 is an example diagram of an application scenario of an image processing method provided by an embodiment of the present disclosure. As shown in FIG. 1, the wearable device is, for example, a head-mounted device 11. When a user wears the head-mounted device 11 on the head, an original image file is obtained by shooting, and after the head-mounted device 11 is placed in a storage apparatus 12, the original image file is sent to the storage apparatus to be processed to obtain a first viewable image.

FIG. 1 is only an exemplary application scenario, which may be used in any wearable device, and the present disclosure does not limit the type of the wearable device.

FIG. 2 is a flowchart of an image processing method provided by an embodiment of the present disclosure. The image processing method is applied to a wearable device, and may include the following steps.

S201: when a user wears the wearable device, controlling a camera to shoot a current environment to obtain an original image file, for example, a first original image file, in response to a shooting instruction.

In the present disclosure, the wearable device includes the camera, and the wearable device includes one selected from a group consisting of a head-mounted display, a headphone, or glasses. The head-mounted display is, for example, VR (Virtual Reality), XR (Extended Reality), MR (Mixed Reality), or AR (Augmented Reality) glasses.

The wearable device has a specific detection function, which can detect whether the wearable device is worn by the user. For example, if the wearable device is a headphone, it may be determined whether two headphones are in a wearing state by means of wearing posture detection of the two headphones.

In an embodiment, the wearable device further includes a voice collecting module, and in response to the shooting instruction includes: collecting voice of a user by the voice collecting module, and analyzing the voice of the user by a model to determine the shooting instruction.

The voice collecting module is, for example, a microphone, and the wearable device may collect the voice of the user by the microphone.

In the present disclosure, the model for analyzing voice is pre-trained, for example, is an LLM (Large Language Model). The model can analyze the voice of the user to determine whether the voice of the user is the shooting instruction. For example, if the user inputs voice "take a photo", it is determined that the voice is the shooting instruction. For another example, if the user inputs voice "what kind of flower is that in front", it is also determined that the voice is the shooting instruction.

In the present disclosure, in addition, the shooting instruction may also be a physical operation instruction. The physical operation instruction refers to that the user uses a physical button on the wearable device to control the camera to shoot the current environment to obtain the original image file. In addition, the shooting instruction may also be implemented in other manners, which is not limited.

Further, the original image file is a file in a RAW format acquired by the camera, and the RAW format refers to an unprocessed image.

In the present disclosure, the wearable device further includes a first image processing module, and the method further includes: processing the original image file by the first image processing module to obtain a second viewable image.

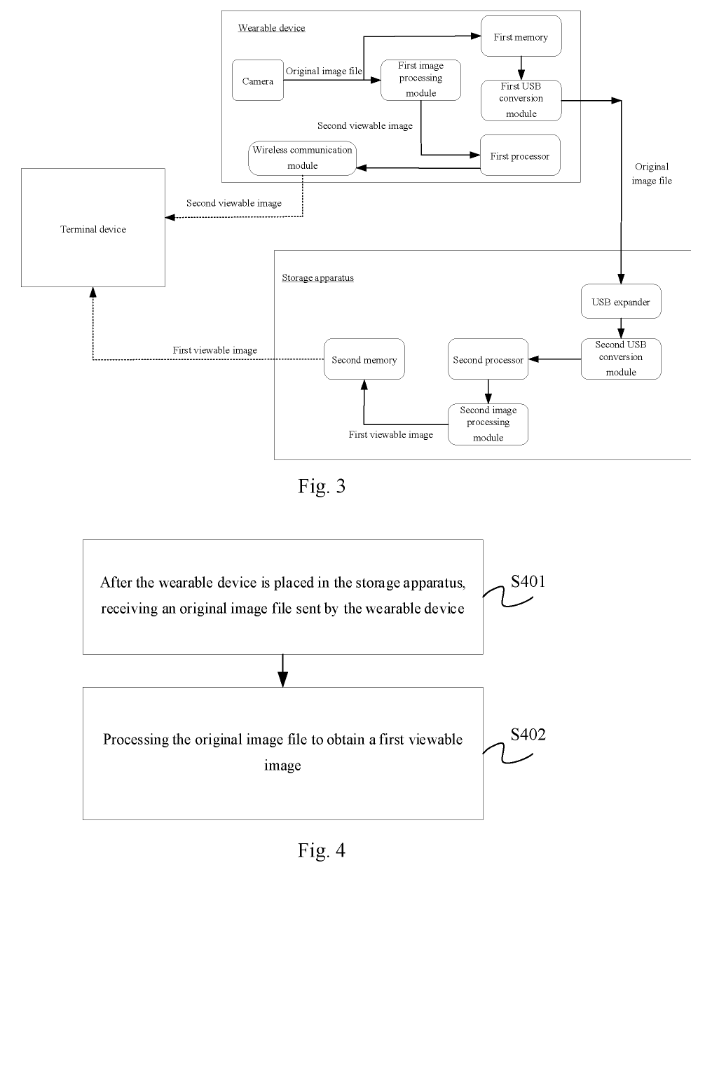

Referring to FIG. 3, the wearable device includes the first image processing module, and the first image processing module uses an ISP chip to process the original image file to obtain the second viewable image.

It may be understood that in the present disclosure, the second viewable image of the current environment may also be obtained in real time by the wearable device.

Referring to FIG. 3, the wearable device further includes a wireless communication module, and the method further includes: when the wearable device is in wireless communication with a terminal device, sending the second viewable image to the terminal device through the wireless communication module.

In the present disclosure, the wireless communication module may send the second viewable image to the terminal device based on Bluetooth or a mobile hotspot. Referring to FIG. 3, the first image processing module sends the second viewable image to the wireless communication module through a first processor, where the first processor may be an MCU (Microcontroller Unit).

It may be understood that the terminal device can display the second viewable image or process the second viewable image. For example, a neural network model is deployed on the terminal device side, and the neural network model can identify content in the second viewable image to obtain an identification result. In addition, the voice of the user and the second viewable image may also be input into the neural network model for processing, and the neural network model may obtain reply content for replying to the voice of the user for the second viewable image. For example, the voice of the user is "what kind of flower is that in front", and the neural network model may obtain reply content "that is a jasmine flower" by identifying the second viewable image.

In the present disclosure, specific processing of the second viewable image by the terminal device is not limited.

S202: after the wearable device is placed in a storage apparatus, sending the original image file, for example, the first original image file, to the storage apparatus, where the storage apparatus is capable of processing the original image file to obtain a first viewable image.

The storage apparatus is configured to store the wearable device when the wearable device is not worn. In addition, the storage apparatus may also have other functions, such as charging the wearable device, interacting with the wearable device, or networking and interacting with other electronic devices.

For example, if the wearable device is a headphone, the storage apparatus is a headphone case. If the wearable device is glasses, the storage apparatus is a glasses case.

Further, after the wearable device is placed in the storage apparatus, the storage apparatus processes the original image file to obtain the first viewable image. It may be understood that the storage apparatus can process to obtain the first viewable image with higher quality. The first viewable image can be sent to a terminal device for display for the user to browse, thereby improving user experience. In addition, the first viewable image may also be sent to a corresponding recognition model for recognition, and the high-quality first viewable image can enable the recognition model to accurately recognize content in the first viewable image, such as the text in the first viewable image.

The wearable device further includes a first memory, and the method further includes: storing the original image file in the first memory; and sending the original image file to the storage apparatus includes: reading the original image file from the first memory when the wearable device is placed in the storage apparatus; and sending the original image file to the storage apparatus in a wired manner.

Referring to FIG. 3, after acquiring the original image file, the camera of the wearable device first stores the original image file in the first memory, and the first memory is, for example, a Flash memory. The wearable device further includes a first USB (Universal Serial Bus) conversion module. When the wearable device is placed in the storage apparatus, the first USB conversion module is wired to the storage apparatus, and the original image file is sent to the storage apparatus in the wired manner.

In an embodiment, the wearable device may also be wirelessly connected to the storage apparatus. When the user wears the wearable device, the original image file is obtained by shooting with the camera, and then the original image file is sent to the storage apparatus in a wireless manner, and the original image file is processed by the storage apparatus to obtain the first viewable image, which can implement real-time processing of the original image file by the storage apparatus.

In summary, the present disclosure provides an image processing method. A camera configured in a wearable device is used to shoot an original image file, but a storage apparatus of the wearable device is used to process the original image file to obtain a first viewable image with high image quality. In addition, it is also possible to process the original image file shot when a user wears the wearable device after the wearable device is stored.

An embodiment of the present disclosure provides an image processing method, which is applied to a storage apparatus. The storage apparatus is configured to store a wearable device when the wearable device is not worn, and the method includes: after the wearable device is placed in the storage apparatus, receiving an original image file, for example, a first original image file, sent by the wearable device; and processing the original image file, for example, the first original image file,.

FIG. 4 is a flowchart of another image processing method provided by an embodiment of the present disclosure, which is applied to a storage apparatus. The storage apparatus is configured to store a wearable device when the wearable device is not worn, and the method specifically includes the following steps.

S401: after the wearable device is placed in the storage apparatus, receiving an original image file sent by the wearable device.

Referring to FIG. 3, the storage apparatus includes a USB expander (USB HUB) and a second USB conversion module. After the wearable device is placed in the storage apparatus, the first USB conversion module of the wearable device is wired to the USB expander of the storage apparatus, and the original image file sent by the first USB conversion module is received by the USB expander, and then the USB expander sends the original image file to a second image processing module through the second USB conversion module and a second processor.

In the present disclosure, the second processor may also be an MCU.

S402: processing the original image file to obtain a first viewable image.

The storage apparatus includes a second image processing module, and the processing the original image file to obtain the first viewable image includes: processing the original image file by using the second image processing module to obtain the first viewable image.

In the present disclosure, the second image processing module uses an ISP chip to process the original image file to obtain the first viewable image.

It may be understood that due to space limitation, the size of the ISP chip in the wearable device is smaller than the size of the ISP chip in the storage apparatus, and therefore the processing capability of the ISP chip in the wearable device is smaller than the processing capability of the ISP chip in the storage apparatus, and the image quality of the second viewable image is lower than the image quality of the first viewable image. It can be seen that in the present disclosure, the original image file is processed by the second image processing module to obtain the first viewable image with higher quality.

Further, the first viewable image is stored in a second memory; and/or the first viewable image is sent to a terminal device.

In an embodiment of the present disclosure, the second memory may be a Flash memory, and the first viewable image is stored in the second memory. It can be understood that because the size of the storage apparatus is larger than the size of the wearable device, the second memory with larger storage space may be provided in the storage apparatus, and therefore the first viewable image corresponding to the original image file shot by the wearable device may be stored in the second memory. Further, the first viewable image stored in the second memory may be read by the storage apparatus, for example, browsed by the user or used for identifying image content in the first viewable image.

In addition, the first viewable image may also be sent to the terminal device. Further, after the wearable device is placed in the storage apparatus, the storage apparatus processes the original image file to obtain the first viewable image. It can be understood that the storage apparatus can process to obtain the first viewable image with higher quality. The first viewable image may be sent to the terminal device for display for the user to browse, thereby improving user experience. In addition, the first viewable image may also be sent to a corresponding recognition model for recognition, and the high-quality first viewable image can enable the recognition model to accurately recognize content in the first viewable image, such as the text in the first viewable image.

Referring to FIG. 3, the wearable device further includes a wireless communication module, and the method further includes: when the wearable device is in wireless communication with the terminal device, sending a second viewable image to the terminal device through the wireless communication module.

In the present disclosure, the storage apparatus further includes a wireless communication module, and the first viewable image may be sent to the terminal device based on the wireless communication module.

It may be understood that the terminal device can display the first viewable image or process the first viewable image. For example, a neural network model is deployed on the terminal device side, and the neural network model can identify content in the first viewable image to obtain an identification result. In addition, the terminal device may also collect inquiry information of the user, and the neural network model inputs the inquiry information of the user and the first viewable image into the neural network model for processing, and the neural network model can obtain reply content for replying to the inquiry information for the first viewable image. For example, the inquiry information of the user is "what does the English in this picture mean", and the neural network model may obtain a Chinese translation corresponding to the English in the first viewable image by identifying the first viewable image.

In the present disclosure, in one scenario, when a user wears the wearable device, the camera of the wearable device is controlled by the shooting instruction to shoot the original image file, and then the original image file is processed by the first image processing module of the wearable device to obtain the second viewable image, and the second viewable image is an image with low quality. The wearable device may send the second viewable image to the terminal device, and the user may view the second viewable image on the terminal device or the second viewable image may be processed by the neural network model in the terminal device.

In another scenario, when the user wears the wearable device, the camera of the wearable device is controlled by the shooting instruction to shoot the original image file, and the second viewable image may be stored by the wearable device in the first memory. After the wearable device is placed in the storage apparatus, the second viewable image in the first memory is sent to the storage apparatus, and the original image file is processed by the second image processing module of the storage apparatus to obtain the first viewable image with higher image quality, and then the storage apparatus may store the first viewable image and/or send the first viewable image to the terminal device. The user may view the first viewable image on the terminal device or the first viewable image may be processed by the neural network model in the terminal device.

In summary, in the present disclosure, the second viewable image may be obtained in real time when the user wears the wearable device, and the first viewable image with higher quality may be obtained after the wearable device is placed in the storage apparatus.

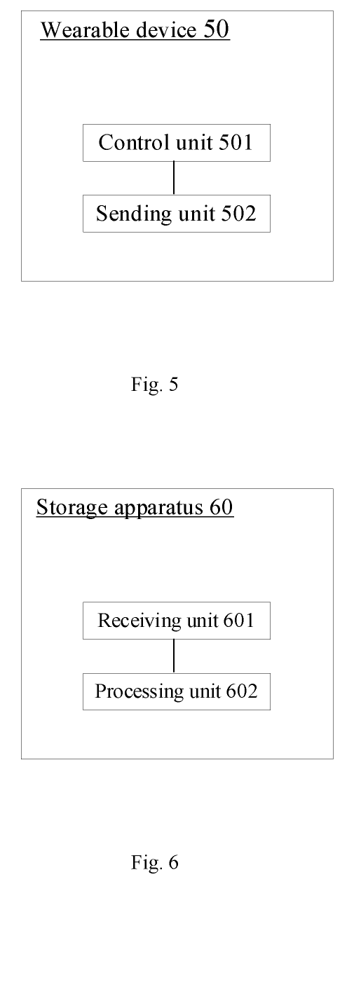

FIG. 5 is a schematic structural diagram of a wearable device provided by an embodiment of the present disclosure. The wearable device 50 includes a camera and may include the following units:

a control unit 501, configured to: when a user wears the wearable device, control the camera to shoot a current environment to obtain an original image file in response to a shooting instruction; and

a sending unit 502, configured to: after the wearable device is placed in a storage apparatus, send the original image file to the storage apparatus, where the storage apparatus is configured to store the wearable device when the wearable device is not worn, and the storage apparatus is capable of processing the original image file to obtain a first viewable image.

In an optional embodiment, the wearable device includes one selected from a group consisting of a head-mounted display, a headphone provided with a camera sensor, and glasses provided with a sensor camera.

In an optional embodiment, the wearable device further includes a first image processing module, and the wearable device further includes a processing unit (not shown), which is configured to process the original image file by the first image processing module to obtain a second viewable image.

In an optional embodiment, the wearable device further includes a wireless communication module, and the sending unit 502 of the wearable device is further configured to: when the wearable device is in wireless communication with a terminal device, send the second viewable image to the terminal device through the wireless communication module.

In an optional embodiment, the wearable device further includes a first memory, and the wearable device further includes a storing unit (not shown), which is configured to store the original image file in the first memory; and

the sending unit 502 is further configured to: when the wearable device is placed in the storage apparatus, read the original image file from the first memory; and send the original image file to the storage apparatus in a wired manner.

In an optional embodiment, the wearable device further includes a voice collecting module, and when responding to the shooting instruction, the control unit 501 is further configured to collect voice of a user by the voice collecting module, and analyze the voice of the user by a model to determine the shooting instruction.

For a specific implementation process of the wearable device provided in the embodiment of the present disclosure, reference may be made to the embodiment of the image processing method, which is not repeated herein.

FIG. 6 is a schematic structural diagram of a storage apparatus provided by an embodiment of the present disclosure, and the storage apparatus 60 may include the following units:

a receiving unit 601, configured to: after a wearable device is placed in the storage apparatus, receive an original image file sent by the wearable device; and

a processing unit 602, configured to process the original image file to obtain a first viewable image.

In an optional embodiment, the storage apparatus includes a second image processing module, and the processing unit 602 is further configured to process the original image file by the second image processing module to obtain the first viewable image.

In an optional embodiment, the storage apparatus further includes a second memory, and the storage apparatus further includes:

a storing unit (not shown), configured to store the first viewable image in the second memory;

and/or a sending unit (not shown), configured to send the first viewable image to a terminal device.

For a specific implementation process of the storage apparatus provided in the embodiment of the present disclosure, reference may be made to the embodiment of the image processing method, which is not repeated herein.

In addition, an embodiment of the present disclosure provides a wearable system, which includes: a wearable device and a storage apparatus, where the storage apparatus is configured to store the wearable device when the wearable device is not worn;

the wearable device is configured to: when a user wears the wearable device, control a camera to shoot a current environment to obtain an original image file in response to a shooting instruction; and after the wearable device is placed in the storage apparatus, send the original image file to the storage apparatus; and

the storage apparatus is configured to process the original image file to obtain a first viewable image.

For a specific implementation process of the wearable system provided in the embodiment of the present disclosure, reference may be made to the embodiment of the image processing method, which is not repeated herein.

In some embodiments, an image processing model is deployed in a storage apparatus corresponding to the wearable device, and the storage apparatus is utilized to perform enhancement processing on an image, so as to improve the photographing effect of the wearable device without increasing the size of the ISP chip in the wearable device.

Correspondingly, the specific steps may include: when a user wears the wearable device, controlling the camera to shoot the current environment to obtain the first original image file in response to the shooting instruction; after the wearable device is placed in the storage apparatus, sending the first original image file to the storage apparatus, so that the storage apparatus processes the first original image file to obtain the second original image file; where the storage apparatus is configured to store the wearable device when the wearable device is not worn; receiving the second original image file returned by the storage apparatus, and processing the second original image file by the first image processing module to obtain the first viewable image.

In this technical solution, after an original image file is obtained by shooting with the camera provided on the wearable device, the storage apparatus may be used to perform image enhancement processing on the original image file, and in this way, the wearable device may generate the first viewable image with high image quality based on the original image file after the image enhancement processing, thereby improving the photographing effect of the wearable device. Moreover, since the storage apparatus is used to perform image enhancement processing on the original image file, a viewable image with high image quality can be obtained even if the image processing module in the wearable device has a small size, thus saving the space occupied by the image processing module, and improving the user experience of the wearable device.

The image processing method provided by the embodiments of the present disclosure will be described in detail below with reference to the drawings.

FIG. 8 is an example diagram of an application scenario of an image processing method provided by an embodiment of the present disclosure. As shown in FIG. 8, the application scenario includes: a smart earphone 11 and an earphone case 12; where the earphone case 12 is configured to store the smart earphone 11 when the smart earphone 11 is not worn. Moreover, data interaction between the smart earphone 11 and the earphone case 12 may be realized in a wired manner. Meanwhile, the earphone case 12 may also charge a battery of the smart earphone 11.

Exemplarily, when a user wears the smart earphone 11, an original image file may be obtained by shooting with the smart earphone 11. After the smart earphone 11 is placed in the earphone case 12, the smart earphone 11 may send the original image file to the earphone case 12, and the earphone case 12 performs image enhancement processing on the original image file, and returns the original image file after the image enhancement processing to the smart earphone 11. In this way, the smart earphone 11 may process the original image file after the image enhancement processing to finally obtain a photo with high image quality.

It should be noted that FIG. 8 is only an exemplary application scenario, which may be used in any wearable device, and the present disclosure does not limit the type of the wearable device.

The following is a specific implementation process of the image processing method according to the embodiments of the present disclosure, and some examples are only examples and not limitations. An execution body of the image processing method involved in the embodiments of the present disclosure is an electronic device, and the electronic device may be a wearable device or the like.

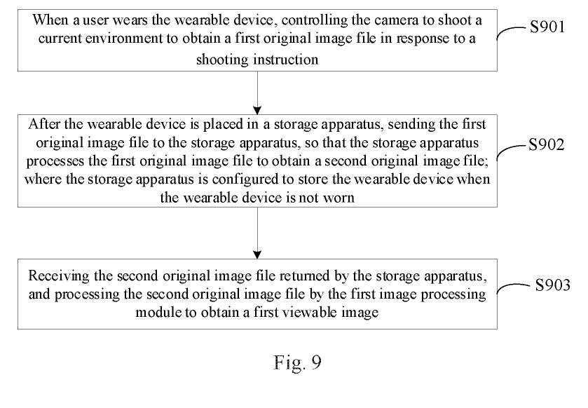

FIG. 9 is a first flowchart of an image processing method provided by an embodiment of the present disclosure, which is applied to a wearable device, where the wearable device includes a first image processing module and a camera. As shown in FIG. 9, the image processing method includes the following steps.

S901: when a user wears the wearable device, controlling the camera to shoot a current environment to obtain a first original image file in response to a shooting instruction.

In the embodiment of the present disclosure, the wearable device may be any electronic device worn on the user. Optionally, the wearable device has a photographing function. Correspondingly, the wearable device includes the first image processing module and the camera. The camera may shoot the current environment to obtain an original image file, and the first image processing module may process the original image file to obtain a viewable image.

In some embodiments, the wearable device includes one selected from a group consisting of a head-mounted display, a smart earphone, smart glasses and a smart bracelet. Optionally, the wearable device has a specific detection function, which may detect whether the wearable device is worn by the user. For example, when the wearable device is an earphone, it may be determined whether the two earphones are in a wearing state through wearing posture detection of the two earphones.

In the embodiment of the present disclosure, the user may trigger the shooting instruction in various ways. For example, the shooting instruction may be triggered through voice control, or may be triggered through a key.

In some embodiments, the wearable device further includes a voice collecting module, and correspondingly, controlling the camera to shoot the current environment to obtain the first original image file in response to the shooting instruction includes: performing voice recognition on voice information in response to collecting the voice information through the voice collecting module, to obtain text information; determining an operating instruction corresponding to the text information through an artificial intelligence language model; in response to the operating instruction being the shooting instruction, controlling the camera to shoot the current environment to obtain the first original image file.

The voice collecting module may be a microphone, and in this case, the wearable device may collect voice information of the user through the microphone. In the embodiment of the present disclosure, the artificial intelligence language model may be a pre-trained language model that may parse the text information to obtain a corresponding operating instruction. Optionally, the artificial intelligence language model may be an LLM (Large Language Model). The large language model may analyze the text information, and then determine the operating instruction corresponding to the text information.

For example, the voice collecting module collects voice information, performs voice recognition on the voice information to obtain text information "take a photo", and determines that the operating instruction is the shooting instruction through the artificial intelligence language model. For another example, the voice collecting module collects voice information, performs voice recognition on the voice information to obtain text information "How about the refrigerator in front", and determines that the operating instruction is the shooting instruction through the artificial intelligence language model.

In other embodiments, the shooting instruction is triggered through a key. Correspondingly, this step is: in response to receiving a trigger operation of a preset photographing key, determining the shooting instruction, and controlling the camera to shoot the current environment to obtain the first original image file. The above key may be a physical key or a touch key.

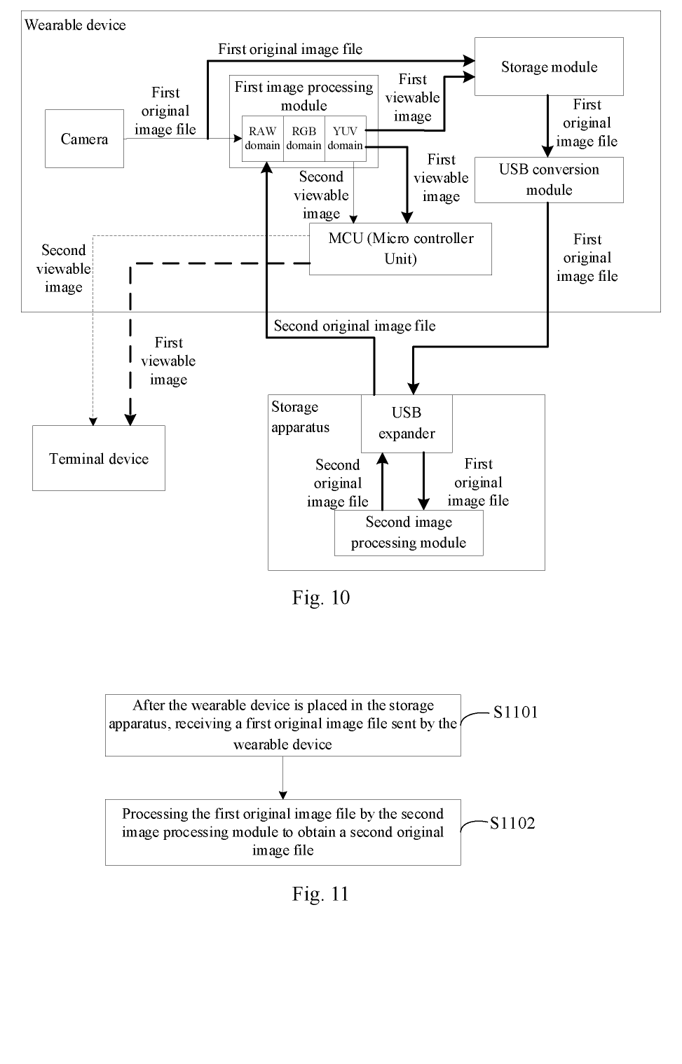

In the embodiment of the present disclosure, as shown in FIG. 10, the first original image obtained by shooting the current environment through the camera is a file in the RAW format. The RAW format refers to an unprocessed image.

S902: after the wearable device is placed in a storage apparatus, sending the first original image file to the storage apparatus, so that the storage apparatus processes the first original image file to obtain a second original image file; where the storage apparatus is configured to store the wearable device when the wearable device is not worn.

In the embodiment of the present disclosure, the storage apparatus is configured to store the wearable device when the wearable device is not worn. In addition, the storage apparatus may also have other functions, such as charging the wearable device, interacting with the wearable device, or connecting to the Internet to interact with other electronic devices. Exemplarily, when the wearable device is a smart earphone, the storage apparatus is an earphone case. When the wearable device is smart glasses, the storage apparatus is a glasses case.

In some embodiments, after the wearable device is placed in the storage apparatus, a wired transmission may be established between the wearable device and the storage apparatus. In this case, the wearable device may send the first original image file to the storage apparatus through the wired transmission.

Optionally, the wearable device further includes a storage module. In this case, when the camera is controlled to shoot the current environment to obtain the first original image file, the first original image file may be stored in the storage module; correspondingly, sending the first original image file to the storage apparatus includes: when the wearable device is placed in the storage apparatus, reading the first original image file from the storage module, and sending the first original image file to the storage apparatus in a wired manner.

Exemplarily, as shown in FIG. 10, after collecting the first original image file, the camera of the wearable device first stores the first original image file in the storage module, and the storage module may be a Flash memory. The wearable device further includes a USB (Universal Serial Bus) conversion module. The storage apparatus includes a USB expander (USB HUB). When the wearable device is placed in the storage apparatus, a wired connection is established between the wearable device and the storage apparatus through the USB conversion module and the USB expander (USB HUB), and the wearable device may send the first original image file to the storage apparatus in a wired manner.

In other embodiments, the wearable device may also be wirelessly connected to the storage apparatus, and after the first original image file is obtained by shooting with the camera, the first original image file may be sent to the storage apparatus wirelessly, so that the storage apparatus processes the first original image file to obtain the second original image file.

It should be noted that, in order to improve the effect of image processing on the first original image file by the storage apparatus, the storage apparatus only performs image processing in the RAW domain (original image signal) on the first original image file, but does not perform image processing in the RGB domain (red, green and blue primary color signals) and the YUV domain (brightness and chroma signals) on the first original image file. The image processing in the RAW domain includes image bad point correction, denoising processing and dynamic range enhancement processing.

S903: receiving the second original image file returned by the storage apparatus, and processing the second original image file by the first image processing module to obtain a first viewable image.

In some embodiments, processing the second original image file by the first image processing module to obtain the first viewable image includes: performing red, green and blue primary color signal processing and brightness and chroma signal processing on the second original image file by the first image processing module, to obtain the first viewable image.

It should be noted that before the wearable device is placed in the storage apparatus, the wearable device may quickly generate a viewable image for the user to preview. Correspondingly, as shown in FIG. 10, the method further includes: performing red, green and blue primary color signal processing and brightness and chroma signal processing on the first original image file by the first image processing module, to obtain a second viewable image.

Optionally, the first image processing module may be an ISP chip. The red, green and blue primary color signal processing is also RGB domain processing, and the brightness and chroma signal processing is also YUV domain processing.

In the embodiment of the present disclosure, when the first viewable image or the second viewable image is generated, the first viewable image or the second viewable image may be sent to a terminal device for the user to preview.

It should be noted that the first viewable image or the second viewable image may be displayed through the terminal device, or the first viewable image or the second viewable image may be processed by an application program on the terminal device to obtain processing result information. The terminal device returns the obtained processing result information to the wearable device, and the user acquires the processing result information through the wearable device.

Exemplarily, the user triggers the shooting instruction through voice information "How about the refrigerator in front", and controls the camera to shoot the current environment (that is, the refrigerator in front) to obtain the first original image file. The first image processing module processes the first original image file to obtain the second viewable image. The wearable device sends the second viewable image to the terminal device. The second viewable image is processed by the application program on the terminal device, the model number of the refrigerator is identified and answer information related to the user's question is generated. The terminal device plays the answer information through the wearable device to realize interaction with the user.

Optionally, the wearable device further includes a communication module, and correspondingly, the method further includes: sending the first viewable image to the terminal device through the communication module; and/or sending the second viewable image to the terminal device through the communication module; where the communication module includes a wired communication module and a wireless communication module.

Optionally, the wireless communication module may be a Bluetooth module or a WIFI (Wireless Fidelity) module. Optionally, the wired communication module may be a USB module.

Further, the transmission speed of image transmission may be asynchronous with the speed of generating the first viewable image. In this case, in order to improve the stability of image transmission, the generated first viewable image may be first stored in the storage module, and then the first viewable image is sent to the terminal device through the storage module.

Optionally, the wearable device further includes a storage module, and the method further includes: storing the first viewable image in the storage module; correspondingly, sending the first viewable image to the terminal device through the communication module includes: reading the first viewable image from the storage module, and sending the first viewable image to the terminal device through the communication module.

Exemplarily, as shown in FIG. 10, the wearable device sends a reading instruction to the storage module through a processor, reads the first viewable image from the storage module, and sends a data transmission instruction to the communication module through the processor, to control the communication module to send the first viewable image to the terminal device. The processor may be an MCU (Micro controller Unit).

The embodiment of the present disclosure provides an image processing method: when a user wears a wearable device, controlling a camera to shoot a current environment to obtain a first original image file in response to a shooting instruction; after the wearable device is placed in a storage apparatus, sending the first original image file to the storage apparatus, so that the storage apparatus processes the first original image file to obtain a second original image file; where the storage apparatus is configured to store the wearable device when the wearable device is not worn; receiving the second original image file returned by the storage apparatus, and processing the second original image file by a first image processing module to obtain a first viewable image. In the embodiment of the present disclosure, after an original image file is obtained by shooting with the camera provided on the wearable device, the storage apparatus may be used to perform image enhancement processing on the original image file, and in this way, the wearable device may generate the first viewable image with high image quality based on the original image file after the image enhancement processing, thereby improving the photographing effect of the wearable device. Moreover, since the storage apparatus is used to perform image enhancement processing on the original image file, a viewable image with high image quality can be obtained even if the image processing module in the wearable device has a small size, therefore, the photographing effect of the wearable device is improved without increasing the size of the image processing module.

FIG. 11 is a flowchart of another image processing method provided by an embodiment of the present disclosure, which is applied to a storage apparatus, where the storage apparatus is configured to store a wearable device when the wearable device is not worn, and the method specifically includes the following steps:

S1101: after the wearable device is placed in the storage apparatus, receiving a first original image file sent by the wearable device.

In the embodiment of the present disclosure, as shown in FIG. 10, the storage apparatus includes a USB expander (USB HUB), and after the wearable device is placed in the storage apparatus, the USB conversion module of the wearable device is wired to the USB expander of the storage apparatus, and then the first original image file sent by the USB conversion module is received through the USB expander, and then the first original image file is sent to a second image processing module through the USB expander.

S1102: processing the first original image file by the second image processing module to obtain a second original image file.

In the embodiment of the present disclosure, this step may include: performing image enhancement processing on the first original image file by an artificial intelligence image processing model in the second image processing module, to obtain the second original image file; where the image enhancement processing includes one or more selected from a group consisting of image bad point correction, denoising processing and dynamic range enhancement processing.

The second image processing module may be a general ISP chip or an artificial intelligence ISP chip. The artificial intelligence ISP chip may perform image enhancement processing on the first original image file through a trained image processing model to obtain the second original image file.

In the embodiment of the present disclosure, after an original image file is obtained by shooting with the camera provided on the wearable device, the storage apparatus may be used to perform image enhancement processing on the original image file, and in this way, the wearable device may generate the first viewable image with high image quality based on the original image file after the image enhancement processing, thereby improving the photographing effect of the wearable device. Moreover, since the storage apparatus is used to perform image enhancement processing on the original image file, a viewable image with high image quality may be obtained even if the image processing module in the wearable device has a small size, therefore, the photographing effect of the wearable device is improved without increasing the size of the image processing module.

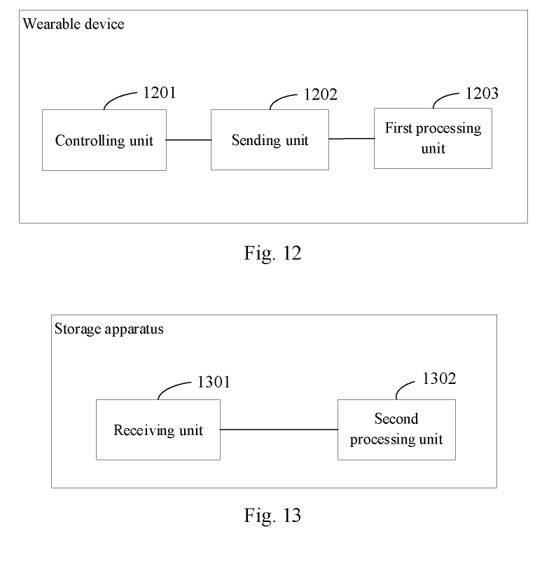

FIG. 12 is a schematic structural diagram of a wearable device provided by an embodiment of the present disclosure, where the wearable device includes a first image processing module and a camera, and may include the following units:

a controlling unit 1201, configured to: when a user wears the wearable device, control the camera to shoot a current environment to obtain a first original image file in response to a shooting instruction;

a sending unit 1202, configured to: after the wearable device is placed in a storage apparatus, send the first original image file to the storage apparatus, so that the storage apparatus processes the first original image file to obtain a second original image file; where the storage apparatus is configured to store the wearable device when the wearable device is not worn; and

a first processing unit 1203, configured to receive the second original image file returned by the storage apparatus, and process the second original image file by the first image processing module to obtain a first viewable image.

In an optional embodiment, the processing unit 1203 processes the second original image file by the first image processing module to obtain the first viewable image, which includes: performing red, green and blue primary color signal processing and brightness and chroma signal processing on the second original image file by the first image processing module, to obtain the first viewable image.

In an optional embodiment, the wearable device further includes a communication module, and the wearable device sends the first viewable image to a terminal device through the communication module; and/or sends a second viewable image to the terminal device through the communication module; where the communication module includes a wired communication module and a wireless communication module.

In an optional embodiment, the wearable device further includes a storage module, and the wearable device stores the first viewable image in the storage module; correspondingly, sending the first viewable image to the terminal device through the communication module includes: reading the first viewable image from the storage module, and sending the first viewable image to the terminal device through the communication module; and/or storing the first original image file in the storage module; correspondingly, the sending unit 1202 sends the first original image file to the storage apparatus, which includes: reading the first original image file from the storage module, and sending the first original image file to the storage apparatus in a wired manner.

In an optional embodiment, the processing unit 1203 is further configured to perform red, green and blue primary color signal processing and brightness and chroma signal processing on the first original image file by the first image processing module, to obtain a second viewable image.

In an optional embodiment, the wearable device further includes a voice collecting module, and correspondingly, the controlling unit 1201 controls the camera to shoot the current environment to obtain the first original image file in response to the shooting instruction, which includes: performing voice recognition on voice information in response to collecting the voice information through the voice collecting module, to obtain text information; determining an operating instruction corresponding to the text information through an artificial intelligence language model; in response to the operating instruction being the shooting instruction, controlling the camera to shoot the current environment to obtain the first original image file.

In an optional embodiment, the wearable device includes one selected from a group consisting of a head-mounted display, a smart earphone, smart glasses and a smart bracelet.

The embodiment of the present disclosure provides a wearable device, and after an original image file is obtained by shooting with a camera provided on the wearable device, a storage apparatus may be used to perform image enhancement processing on the original image file, and in this way, the wearable device may generate a first viewable image with high image quality based on the original image file after the image enhancement processing, thereby improving the photographing effect of the wearable device. Moreover, since the storage apparatus is used to perform image enhancement processing on the original image file, a viewable image with high image quality may be obtained even if an image processing module in the wearable device has a small size, therefore, the photographing effect of the wearable device is improved without increasing the size of the image processing module.

For the specific implementation process of the wearable device provided by the embodiment of the present disclosure, reference may be made to the embodiments of the image processing method, which will not be repeated herein.

FIG. 13 is a schematic structural diagram of a storage apparatus provided by an embodiment of the present disclosure, where the storage apparatus is configured to store a wearable device when the wearable device is not worn, and may include the following units:

a receiving unit 1301, configured to: after the wearable device is placed in the storage apparatus, receive a first original image file sent by the wearable device; and

a second processing unit 1302, configured to process the first original image file by a second image processing module to obtain a second original image file.

In an optional embodiment, the second processing unit 1302 processes the first original image file by the second image processing module to obtain the second original image file, which includes: performing image enhancement processing on the first original image file by an artificial intelligence image processing model in the second image processing module, to obtain the second original image file; where the image enhancement processing includes one or more selected from a group consisting of image bad point correction, denoising processing and dynamic range enhancement processing.

The embodiment of the present disclosure provides a storage apparatus, and after an original image file is obtained by shooting with a camera provided on the wearable device, the storage apparatus may be used to perform image enhancement processing on the original image file, and in this way, the wearable device may generate a first viewable image with high image quality based on the original image file after the image enhancement processing, thereby improving the photographing effect of the wearable device. Moreover, since the storage apparatus is used to perform image enhancement processing on the original image file, a viewable image with high image quality may be obtained even if an image processing module in the wearable device has a small size, therefore, the photographing effect of the wearable device is improved without increasing the size of the image processing module.

For the specific implementation process of the storage apparatus provided by the embodiment of the present disclosure, reference may be made to the embodiments of the image processing method, which will not be repeated herein.

In addition, an embodiment of the present disclosure further provides a wearable system, including: a wearable device and a storage apparatus, where the storage apparatus is configured to store the wearable device when the wearable device is not worn;

the wearable device is configured to: when a user wears the wearable device, control a camera to shoot a current environment to obtain a first original image file in response to a shooting instruction; and after the wearable device is placed in the storage apparatus, send the first original image file to the storage apparatus;

the storage apparatus is configured to: after the wearable device is placed in the storage apparatus, receive the first original image file sent by the wearable device; and process the first original image file by a second image processing module to obtain a second original image file; and

the wearable device is further configured to receive the second original image file returned by the storage apparatus, and process the second original image file by a first image processing module to obtain a first viewable image.

For the specific implementation process of the wearable system provided by the embodiment of the present disclosure, reference may be made to the embodiments of the image processing method, which will not be repeated herein.

In order to implement the above embodiments, an embodiment of the present disclosure further provides a computer-readable storage medium, where a computer-executable instruction is stored in the computer-readable storage medium. When the computer-executable instruction is executed by a processor, the image processing method according to any one of the above embodiments is implemented.

In order to implement the above embodiments, an embodiment of the present disclosure further provides a computer program product, which includes a computer program. When the computer program is executed by a processor, the image processing method according to any one of the above embodiments is implemented.

In order to implement the above embodiments, an embodiment of the present disclosure further provides an electronic device, which includes: a processor and a memory;

the memory stores a computer-executable instruction; and

the processor executes the computer-executable instruction stored in the memory to cause the processor to execute the image processing method according to any one of the above embodiments.

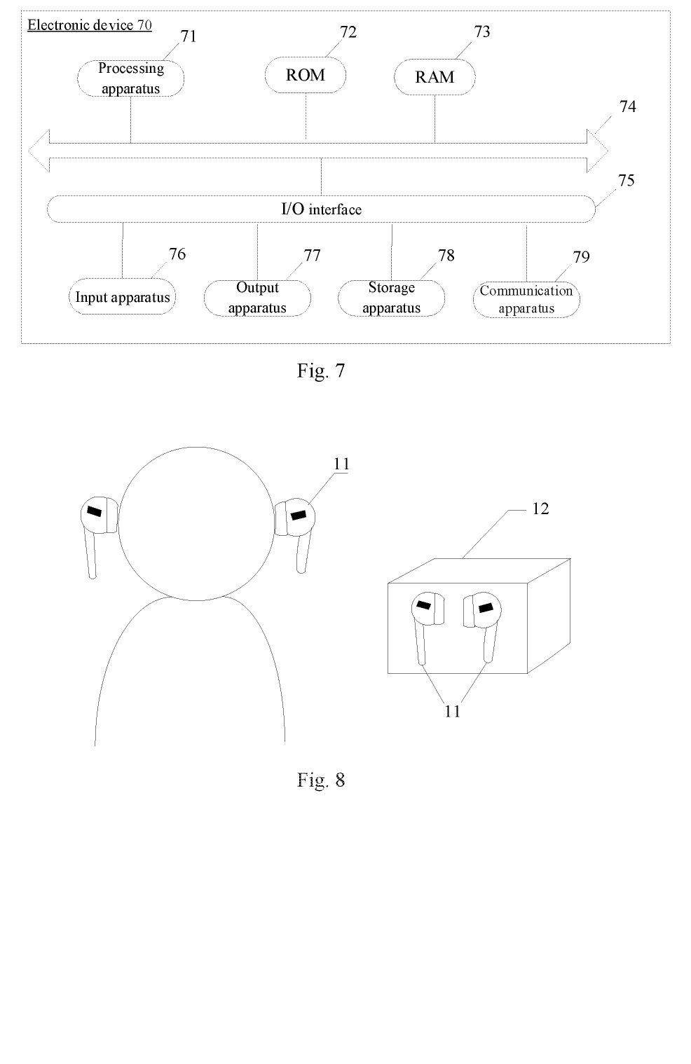

FIG. 7 is a schematic structural diagram of an electronic device provided by an embodiment of the present disclosure, and the electronic device 70 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), and an in-vehicle terminal (such as an in-vehicle navigation terminal), and a fixed terminal such as a digital TV and a desktop computer. The electronic device shown in FIG. 7 is only an example and should not impose any limitation on the function and scope of use of the embodiments of the present disclosure.

As shown in FIG. 7, the electronic device 70 may include a processing apparatus (e.g., a central processing unit, a graphics processor, etc.) 71, which may perform various appropriate actions and processes according to a program stored in a read-only memory (abbreviated as ROM) 72 or a program loaded from a storage apparatus 78 into a random access memory (abbreviated as RAM) 73. In the RAM 73, various programs and data necessary for the operation of the electronic device 70 are also stored. The processing apparatus 71, ROM 72, and RAM 73 are connected to each other through a bus 74. An input/output (I/O) interface 75 is also connected to the bus 74.

Usually, the following apparatuses may be connected to the I/O interface 75: an input apparatus 76 including, for example, a touch screen, a touchpad, a keyboard, a mouse, a camera, a microphone, an accelerometer, and a gyroscope; an output apparatus 77 including, for example, a liquid crystal display (abbreviated as LCD), a speaker, and a vibrator; a storage apparatus 78 including, for example, a magnetic tape and a hard disk; and a communication apparatus 79. The communication apparatus 79 may allow the electronic device 70 to perform wireless or wired communication with other devices to exchange data. Although FIG. 7 shows the electronic device 70 having various apparatuses, it should be understood that it is not required to implement or have all of the apparatuses shown. More or fewer apparatuses may alternatively be implemented or provided.

In particular, according to the embodiments of the present disclosure, the process described above with reference to the flowchart may be implemented as a computer software program. For example, the embodiments of the present disclosure include a computer program product, which includes a computer program carried on a computer-readable medium, and the computer program contains program codes for performing the method shown in the flowchart. In such an embodiment, the computer program may be downloaded and installed from a network through the communication apparatus 79, or installed from the storage apparatus 78, or installed from the ROM 72. When the computer program is executed by the processing apparatus 71, the functions defined in the method of the embodiments of the present disclosure are executed.

It should be noted that the above computer-readable medium according to the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and the computer-readable program code is carried in the data signal. This propagated data signal may be in multiple forms, including, but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be sent in any suitable medium, including, but not limited to, a wire, an optical cable, an RF (radio frequency), or any suitable combination of the above.

The above computer-readable medium may be included in the above electronic device, or may exist alone without being assembled into the electronic device.

The above computer-readable medium carries one or more programs, which, when executed by the electronic device, cause the electronic device to perform the method shown in the above embodiment.

The computer program code for carrying out the operations of the present disclosure may be written in one or more programming languages or a combination thereof, where the programming languages include object-oriented programming languages such as Java, Smalltalk, and C++, and conventional procedural programming languages such as "C" language or similar programming languages. The program code may be executed entirely on a target user computer, partly on the target user computer, as a stand-alone software package, partly on the target user computer and partly on a remote computer, or entirely on the remote computer or server. In the case of the remote computer, the remote computer may be connected to the target user computer through any kind of network, including a local area network (abbreviated as LAN) or a wide area network (abbreviated as WAN), or it may be connected to an external computer (for example, connected by using Internet provided by an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or flowchart, and a combination of the blocks in the block diagram and/or flowchart may be implemented by a dedicated hardware-based system that executes specified functions or operations, or by a combination of dedicated hardware and computer instructions.

The involved units described in the embodiments of the present disclosure may be implemented by software or hardware. The name of a unit does not constitute a limitation on the unit itself under certain circumstances, for example, the first acquiring unit may also be described as "a unit for acquiring at least two internet protocol addresses".

The functions described herein may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection on the basis of one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, an image processing method is provided, which is applied to a wearable device. The wearable device includes a camera, and the method includes:

when a user wears the wearable device, controlling the camera to shoot a current environment to obtain an original image file in response to a shooting instruction; and

after the wearable device is placed in a storage apparatus, sending the original image file to the storage apparatus, where the storage apparatus is configured to store the wearable device when the wearable device is not worn, and the storage apparatus is capable of processing the original image file.

According to one or more embodiments of the present disclosure, an image processing method is provided, which is applied to a wearable device. The wearable device includes a camera, and the method includes:

when a user wears the wearable device, controlling the camera to shoot a current environment to obtain an original image file in response to a shooting instruction; and

after the wearable device is placed in a storage apparatus, sending the original image file to the storage apparatus, where the storage apparatus is configured to store the wearable device when the wearable device is not worn, and the storage apparatus is capable of processing the original image file to obtain a first viewable image.

According to one or more embodiments of the present disclosure, the wearable device further includes a first image processing module, and the method further includes:

processing the original image file by the first image processing module to obtain a second viewable image.

According to one or more embodiments of the present disclosure, the wearable device further includes a wireless communication module, and the method further includes:

when the wearable device is in wireless communication with a terminal device, sending the second viewable image to the terminal device through the wireless communication module.

According to one or more embodiments of the present disclosure, the wearable device further includes a first memory, and the method further includes:

storing the original image file in the first memory; and

sending the original image file to the storage apparatus includes:

reading the original image file from the first memory when the wearable device is placed in the storage apparatus; and

sending the original image file to the storage apparatus in a wired manner.

According to one or more embodiments of the present disclosure, the wearable device further includes a voice collecting module, and in response to the shooting instruction includes:

collecting voice of a user by the voice collecting module, and analyzing the voice of the user by a model to determine the shooting instruction.

According to one or more embodiments of the present disclosure, an image processing method is provided, which is applied to a storage apparatus. The storage apparatus is configured to store a wearable device when the wearable device is not worn, and the method includes:

after the wearable device is placed in the storage apparatus, receiving an original image file sent by the wearable device; and

processing the original image file.

According to one or more embodiments of the present disclosure, an image processing method is provided, which is applied to a storage apparatus. The storage apparatus is configured to store a wearable device when the wearable device is not worn, and the method includes:

after the wearable device is placed in the storage apparatus, receiving an original image file sent by the wearable device; and

processing the original image file to obtain a first viewable image.

According to one or more embodiments of the present disclosure, the storage apparatus includes a second image processing module, and processing the original image file to obtain the first viewable image includes:

processing the original image file by the second image processing module to obtain the first viewable image.

According to one or more embodiments of the present disclosure, the storage apparatus further includes a second memory, and the method further includes:

storing the first viewable image in the second memory;

and/or sending the first viewable image to a terminal device.

According to one or more embodiments of the present disclosure, a wearable device is provided. The wearable device includes a camera and the wearable device includes:

a control unit, configured to: when a user wears the wearable device, control the camera to shoot a current environment to obtain an original image file in response to a shooting instruction; and

a sending unit, configured to: after the wearable device is placed in a storage apparatus, send the original image file to the storage apparatus, where the storage apparatus is configured to store the wearable device when the wearable device is not worn, and the storage apparatus is capable of processing the original image file to obtain a first viewable image.

According to one or more embodiments of the present disclosure, the wearable device includes one selected from a group consisting of a head-mounted display, a headphone provided with a camera sensor, and glasses provided with a sensor camera.

According to one or more embodiments of the present disclosure, a storage apparatus is provided, which is configured to store a wearable device when the wearable device is not worn. The storage apparatus includes:

a receiving unit, configured to: after the wearable device is placed in the storage apparatus, receive an original image file sent by the wearable device; and

a processing unit, configured to process the original image file to obtain a first viewable image.

According to one or more embodiments of the present disclosure, a wearable system is provided, which includes: a wearable device and a storage apparatus, where the storage apparatus is configured to store the wearable device when the wearable device is not worn;

the wearable device is configured to: when a user wears the wearable device, control a camera to shoot a current environment to obtain an original image file in response to a shooting instruction; and after the wearable device is placed in the storage apparatus, send the original image file to the storage apparatus; and

the storage apparatus is configured to process the original image file.

According to one or more embodiments of the present disclosure, a wearable system is provided, which includes: a wearable device and a storage apparatus, where the storage apparatus is configured to store the wearable device when the wearable device is not worn;

the wearable device is configured to: when a user wears the wearable device, control a camera to shoot a current environment to obtain an original image file in response to a shooting instruction; and after the wearable device is placed in the storage apparatus, send the original image file to the storage apparatus; and

the storage apparatus is configured to process the original image file to obtain a first viewable image.

An image processing method is provided, which is applied to a wearable device, where the wearable device includes a first image processing module and a camera, and the method includes:

when a user wears the wearable device, controlling the camera to shoot a current environment to obtain a first original image file in response to a shooting instruction;

after the wearable device is placed in a storage apparatus, sending the first original image file to the storage apparatus, so that the storage apparatus processes the first original image file to obtain a second original image file; where the storage apparatus is configured to store the wearable device when the wearable device is not worn; and

receiving the second original image file returned by the storage apparatus, and processing the second original image file by the first image processing module to obtain a first viewable image.

According to one or more embodiments of the present disclosure, processing the second original image file by the first image processing module to obtain the first viewable image, includes: performing red, green and blue primary color signal processing and brightness and chroma signal processing on the second original image file by the first image processing module, to obtain the first viewable image.

According to one or more embodiments of the present disclosure, the wearable device further includes a communication module, and the method further includes: sending the first viewable image to a terminal device through the communication module; and/or sending a second viewable image to the terminal device through the communication module; where the communication module includes a wired communication module and a wireless communication module.

According to one or more embodiments of the present disclosure, the wearable device further includes a storage module, and the method further includes: storing the first viewable image in the storage module; correspondingly, sending the first viewable image to the terminal device through the communication module includes: reading the first viewable image from the storage module, and sending the first viewable image to the terminal device through the communication module; and/or storing the first original image file in the storage module; correspondingly, sending the first original image file to the storage apparatus includes: reading the first original image file from the storage module, and sending the first original image file to the storage apparatus in a wired manner.

According to one or more embodiments of the present disclosure, before the wearable device is placed in the storage apparatus, the method further includes: performing red, green and blue primary color signal processing and brightness and chroma signal processing on the first original image file by the first image processing module, to obtain a second viewable image.

According to one or more embodiments of the present disclosure, the wearable device further includes a voice collecting module, and correspondingly, controlling the camera to shoot the current environment to obtain the first original image file in response to the shooting instruction, includes: performing voice recognition on voice information in response to collecting the voice information through the voice collecting module, to obtain text information; determining an operating instruction corresponding to the text information through an artificial intelligence language model; in response to the operating instruction being the shooting instruction, controlling the camera to shoot the current environment to obtain the first original image file.

An image processing method is provided, which is applied to a storage apparatus, where the storage apparatus is configured to store a wearable device when the wearable device is not worn, and the method includes:

after the wearable device is placed in the storage apparatus, receiving a first original image file sent by the wearable device; and

processing the first original image file by a second image processing module to obtain a second original image file.

According to one or more embodiments of the present disclosure, processing the first original image file by the second image processing module to obtain the second original image file, includes:

performing image enhancement processing on the first original image file by an artificial intelligence image processing model in the second image processing module, to obtain the second original image file; where the image enhancement processing includes one or more selected from a group consisting of image bad point correction, denoising processing and dynamic range enhancement processing.

A wearable device is provided, where the wearable device includes a first image processing module and a camera, and the wearable device includes:

a controlling unit, configured to: when a user wears the wearable device, control the camera to shoot a current environment to obtain a first original image file in response to a shooting instruction;

a sending unit, configured to: after the wearable device is placed in a storage apparatus, send the first original image file to the storage apparatus, so that the storage apparatus processes the first original image file to obtain a second original image file; where the storage apparatus is configured to store the wearable device when the wearable device is not worn; and

a first processing unit, configured to receive the second original image file returned by the storage apparatus, and process the second original image file by the first image processing module to obtain a first viewable image.

According to one or more embodiments of the present disclosure, the wearable device includes one selected from a group consisting of a head-mounted display, a smart earphone, smart glasses and a smart bracelet.

According to one or more embodiments of the present disclosure, the processing unit processes the second original image file by the first image processing module to obtain the first viewable image, which includes: performing red, green and blue primary color signal processing and brightness and chroma signal processing on the second original image file by the first image processing module, to obtain the first viewable image.

According to one or more embodiments of the present disclosure, the wearable device further includes a communication module, the wearable device sends the first viewable image to a terminal device through the communication module; and/or sends the second viewable image to the terminal device through the communication module; where the communication module includes a wired communication module and a wireless communication module.

According to one or more embodiments of the present disclosure, the wearable device further includes a storage module, the wearable device stores the first viewable image in the storage module; correspondingly, sending the first viewable image to the terminal device through the communication module includes: reading the first viewable image from the storage module, and sending the first viewable image to the terminal device through the communication module; and/or stores the first original image file in the storage module; correspondingly, the sending unit sends the first original image file to the storage apparatus, includes: reading the first original image file from the storage module, and sending the first original image file to the storage apparatus in a wired manner.

According to one or more embodiments of the present disclosure, the processing unit is further configured to perform red, green and blue primary color signal processing and brightness and chroma signal processing on the first original image file by the first image processing module, to obtain a second viewable image.

According to one or more embodiments of the present disclosure, the wearable device further includes a voice collecting module, and correspondingly, the controlling unit controls the camera to shoot the current environment to obtain the first original image file in response to the shooting instruction, includes: performing voice recognition on voice information in response to collecting the voice information through the voice collecting module, to obtain text information; determining an operating instruction corresponding to the text information through an artificial intelligence language model; in response to the operating instruction being the shooting instruction, controlling the camera to shoot the current environment to obtain the first original image file.

According to one or more embodiments of the present disclosure, the wearable device includes one selected from a group consisting of a head-mounted display, a smart earphone, smart glasses and a smart bracelet.

A storage apparatus is provided, where the storage apparatus is configured to store a wearable device when the wearable device is not worn, and the storage apparatus includes:

a receiving unit, configured to: after the wearable device is placed in the storage apparatus, receive a first original image file sent by the wearable device; and

a second processing unit, configured to process the first original image file by a second image processing module to obtain a second original image file.

According to one or more embodiments of the present disclosure, the second processing unit processes the first original image file by the second image processing module to obtain the second original image file, which includes: performing image enhancement processing on the first original image file by an artificial intelligence image processing model in the second image processing module, to obtain the second original image file; where the image enhancement processing includes one or more of image bad point correction, denoising processing and dynamic range enhancement processing.

A wearable system is provided, the wearable system includes: a wearable device and a storage apparatus, where the storage apparatus is configured to store the wearable device when the wearable device is not worn;

the wearable device is configured to: when a user wears the wearable device, control a camera to shoot a current environment to obtain a first original image file in response to a shooting instruction; and after the wearable device is placed in the storage apparatus, send the first original image file to the storage apparatus;

the storage apparatus is configured to: after the wearable device is placed in the storage apparatus, receive the first original image file sent by the wearable device; and process the first original image file by a second image processing module to obtain a second original image file; and

the wearable device is further configured to receive the second original image file returned by the storage apparatus, and process the second original image file by a first image processing module to obtain a first viewable image.

According to one or more embodiments of the present disclosure, an electronic device is provided, which includes: at least one processor and a memory;

the memory stores a computer-executable instruction; and

the at least one processor executes the computer-executable instruction stored in the memory to cause the at least one processor to execute the image processing method according to various possible designs of the above embodiments.

According to one or more embodiments of the present disclosure, a computer-readable storage medium is provided, where a computer-executable instruction is stored in the computer-readable storage medium. When the computer-executable instruction is executed by a processor, the image processing method according to various possible designs of the above embodiments.

According to one or more embodiments of the present disclosure, a computer program product is provided, which includes a computer program. When the computer program is executed by a processor, the image processing method according to various possible designs of the above embodiments is implemented.

The above description is only preferred embodiments of the present disclosure and an explanation of the technical principles employed. Those skilled in the art should understand that the scope of disclosure involved in the present disclosure is not limited to the technical solutions formed by the specific combinations of the above technical features, and should also cover other technical solutions formed by any combination of the above technical features or their equivalent features without departing from the above disclosed concept. For example, a technical solution formed by replacing the above features with technical features with similar functions disclosed in the present disclosure (but not limited thereto) also falls within the scope of the present disclosure.

Additionally, although operations are depicted in a particular order, it should not be understood that these operations are required to be performed in a specific order as illustrated or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms for implementing the claims.

1. An image processing method, applied to a wearable device, wherein the wearable device comprises a camera, and the method comprises:
when a user wears the wearable device, controlling the camera to shoot a current environment to obtain a first original image file in response to a shooting instruction; and
after the wearable device is placed in a storage apparatus, sending the first original image file to the storage apparatus, wherein the storage apparatus is configured to store the wearable device when the wearable device is not worn, and the storage apparatus is capable of processing the first original image file.

2. The image processing method of claim 1, wherein the storage apparatus being capable of processing the first original image file, comprises:
the storage apparatus being capable of processing the first original image file to obtain a first viewable image.

3. The image processing method of claim 2, wherein the wearable device further comprises a first image processing module, and the method further comprises:
processing the first original image file by using the first image processing module to obtain a second viewable image.

4. The image processing method of claim 3, wherein the wearable device further comprises a wireless communication module, and the method further comprises:
when the wearable device is in wireless communication with a terminal device, sending the second viewable image to the terminal device through the wireless communication module.

5. The image processing method of claim 2, wherein the wearable device further comprises a first memory, and the method further comprises:
storing the first original image file in the first memory; and
the sending the first original image file to the storage apparatus comprises:
reading the first original image file from the first memory when the wearable device is placed in the storage apparatus; and
sending the first original image file to the storage apparatus in a wired manner.

6. The image processing method of claim 2, wherein the wearable device further comprises a voice collecting module, and in response to the shooting instruction comprises:
collecting voice of a user by the voice collecting module, and analyzing the voice of the user by a model to determine the shooting instruction.

7. The image processing method of claim 1, wherein the wearable device further comprises a first image processing module, the storage apparatus being capable of processing the first original image file, comprises:
the storage apparatus processing the first original image file to obtain a second original image file; and
the method comprises:
receiving the second original image file returned by the storage apparatus, and processing the second original image file by the first image processing module to obtain a first viewable image.

8. The image processing method of claim 7, wherein processing the second original image file by the first image processing module to obtain the first viewable image, comprises:
performing red, green and blue primary color signal processing and brightness and chroma signal processing on the second original image file by the first image processing module, to obtain the first viewable image.

9. The image processing method of claim 8, wherein the wearable device further comprises a communication module, and the method further comprises:
sending the first viewable image to a terminal device through the communication module; and/or sending a second viewable image to the terminal device through the communication module;
wherein the communication module comprises a wired communication module and a wireless communication module.

10. The image processing method of claim 9, wherein the wearable device further comprises a storage module, and the method further comprises:
storing the first viewable image in the storage module; sending the first viewable image to the terminal device through the communication module comprises: reading the first viewable image from the storage module, and sending the first viewable image to the terminal device through the communication module; and/or,
storing the first original image file in the storage module; sending the first original image file to the storage apparatus comprises: reading the first original image file from the storage module, and sending the first original image file to the storage apparatus in a wired manner.

11. The image processing method of claim 7, wherein before the wearable device is placed in the storage apparatus, the method further comprises:
performing red, green and blue primary color signal processing and brightness and chroma signal processing on the first original image file by the first image processing module, to obtain a second viewable image.

12. The image processing method of claim 7, wherein the wearable device further comprises a voice collecting module,
controlling the camera to shoot the current environment to obtain the first original image file in response to the shooting instruction, comprises:
performing voice recognition on voice information in response to collecting the voice information through th
determining an operating instruction corresponding to the text information through an artificial intelligence language model; and
in response to the operating instruction being the shooting instruction, controlling the camera to shoot the current environment to obtain the first original image file.

13. An image processing method, applied to a storage apparatus, wherein the storage apparatus is configured to store a wearable device when the wearable device is not worn, and the method comprises:
after the wearable device is placed in the storage apparatus, receiving a first original image file sent by the wearable device; and
processing the first original image file.

14. The image processing method of claim 13, wherein processing the first original image file, comprises:
processing the first original image file to obtain a first viewable image.

15. The image processing method of claim 14, wherein the storage apparatus comprises a second image processing module, and the processing the first original image file to obtain the first viewable image comprises:
processing the first original image file by using the second image processing module to obtain the first viewable image.

16. The image processing method of claim 14, wherein the storage apparatus further comprises a second memory, and the method further comprises:
storing the first viewable image in the second memory;
and/or sending the first viewable image to a terminal device.

17. The image processing method of claim 13, wherein processing the first original image file, comprises:
processing the first original image file by a second image processing module to obtain a second original image file.

18. The image processing method of claim 17, wherein processing the first original image file by the second image processing module to obtain the second original image file, comprises:
performing image enhancement processing on the first original image file by an artificial intelligence image processing model in the second image processing module, to obtain the second original image file; wherein the image enhancement processing comprises one or more selected from a group consisting of image bad point correction, denoising processing and dynamic range enhancement processing.

19. A wearable system, comprising: a wearable device and a storage apparatus, wherein the storage apparatus is configured to store the wearable device when the wearable device is not worn;
the wearable device is configured to: when a user wears the wearable device, control a camera to shoot a current environment to obtain a first original image file in response to a shooting instruction; and after the wearable device is placed in the storage apparatus, send the first original image file to the storage apparatus; and
the storage apparatus is configured to process the first original image file.

20. A wearable device, comprising: a processor and a memory;
the memory stores a computer-executable instruction; and
the processor executes the computer-executable instruction stored in the memory to cause the processor to execute the image processing method according to claim 1.
